(19) United States
(12) Patent Application Publication
(10) Pub. No.: US 2015/0276113 A1
(43) Pub. Date: Oct. 1, 2015

(54) ANNULUS DESIGN FOR PIPE-IN-PIPE SYSTEM

(71) Applicants: Ronald M. Bass, Houston, TX (US); Robert H. Rogers, Spring, TX (US); Are Bruaset, Ranheim (NO); Adam Jackson, Trondheim (NO)

(72) Inventors: Ronald M. Bass, Houston, TX (US); Robert H. Rogers, Spring, TX (US); Are Bruaset, Ranheim (NO); Adam Jackson, Trondheim (NO)

(21) Appl. No.: 14/658,320

(22) Filed: Mar. 16, 2015

Related U.S. Application Data
(60) Provisional application No. 62/113,903, filed on Feb. 9, 2015.
(60) Provisional application No. 61/970,768, filed on Mar. 26, 2014.

(51) Int. Cl. F16L 53/00; H05B 3/44

(52) U.S. Cl. CPC F16L 53/007; H05B 3/44

(57) ABSTRACT

A pipe-in-pipe system, including: an outer pipe; an inner pipe disposed within the outer pipe; a mid line assembly configured to connect the outer pipe and the inner pipe to a current source; and an annulus region between an outer surface of the inner pipe and an inner surface of the outer pipe, wherein the annulus region includes a conductive or semiconductive electrical path configured to carry current between the inner pipe and the outer pipe.

### CROSS-REFERENCE TO RELATED APPLICATION

This application claims the benefit of U.S. Provisional Application No. 61/970,768, filed Mar. 26, 2014, and U.S. Provisional Application No. 62/113,903, filed Feb. 9, 2015, the entirety of which are incorporated by reference herein.

### TECHNOLOGICAL FIELD

Exemplary embodiments described herein pertain to pipe-in-pipe direct electrical heating of subsea pipelines. More particularly, the exemplary embodiments describe an annulus design for such pipe-in-pipe direct electrical heating of subsea pipelines.

### BACKGROUND

This section is intended to introduce various aspects of the art, which may be associated with exemplary embodiments of the present technological advancement. This discussion is believed to assist in providing a framework to facilitate a better understanding of particular aspects of the present invention. Accordingly, it should be understood that this section should be read in this light, and not necessarily as admissions of prior art.

Pipe-in-Pipe Direct Electrical Heating (PIP DEH) of subsea pipelines uses heat to prevent or remediate pipeline blockages that may result from gelling or gas hydrates, or to reduce drag from viscous fluids by maintaining them at an elevated temperature. In PIP DEH systems, alternating electric current is passed directly through the pipe wall so that the pipe functions as an electric heating element.

A conventional pipe-in-pipe (PIP) system has an inner pipe to carry a fluid and an outer pipe to provide a space near atmospheric pressure for low density thermal insulation. The space between the inner and outer pipe is called the annulus. The annulus of a PIP DEH system can provide both thermal and electrical insulation that is electrically robust in the presence of possible contaminants such as water (condensed water, sea spray or rain water), pipe scale or construction debris. In addition, electrically insulating shear stop elements in the annulus can be provided periodically, for example every 200-1000 meters (m) to avoid compressive failure of the inner pipe, without interrupting the flow of heating current. The shear stop elements mechanically connect the inner pipe, through its electrical insulation, to the outer pipe. Electrically insulating water stop elements can be provided periodically, for example approximately every 1000 m, to prevent flooding of the entire annulus in event of unplanned abandonment during installation. Conducting shear stop elements and water stop elements are also possible provided insulation on the inner pipe remains functional.

Steel bulkheads, used for both shear stop elements and water stop elements in unheated pipe in pipe systems, would short-circuit the electric heating system.

Electrically conducting or semiconductive centralizers can be disposed in the annulus every 2-8 meters to separate the inner and outer pipe in order to prevent crushing of low density thermal insulation, maintain electrical contact between inner pipe semiconductive coating and outer pipe, and prevent buckling of the outer pipe.

Existing PIP DEH systems have been used only for heating during brief periods when the pipeline was shut down. In existing PIP DEH systems, the thermal insulation in the annulus also served as electrical insulation, with some modifications, and for centralization. The thermal insulation is not designed for the purpose of electrical insulation and is somewhat vulnerable to electrical failure from effects of contamination. The technological advancement is designed to operate at significantly higher voltages than existing systems to enable heating of longer pipelines in the presence of electrical contamination, further increasing the requirement for robust electrical insulation. Existing pipe-in-pipe heating systems are described in the following U.S. patents, each of which is incorporated herein by reference in its entirety: U.S. Pat. Nos. 6,142,707, 6,171,025, 6,179,523, 6,264,401, 6,292,627, 6,315,497, 6,371,693, 6,686,745, 6,688,900, 6,707,012, 6,714,018, 6,726,831, 6,739,803, 6,814,146, 6,937,030, and 7,033,113.

### SUMMARY

A pipe-in-pipe system, including: an outer pipe; an inner pipe disposed within the outer pipe; and an annulus region between an outer surface of the inner pipe and an inner surface of the outer pipe, wherein the annulus region includes electrical insulation disposed on the outer surface of the inner pipe, a semiconductive or conductive layer (first layer) disposed on the electrical insulation, a semiconductive or conductive layer (second layer) disposed on the inner surface of the outer pipe, and a low resistance centralizer that electrically connects the semiconductive or conductive layer disposed on the inner surface of the outer pipe across an air gap to the semiconductive or conductive layer disposed on the electrical insulation.

The system can further include: a mid line assembly configured to connect the outer pipe and the inner pipe to a power supply, wherein a terminal end of the radially innermost semiconductive or conductive layer (first layer) stops short of where the mid line assembly connects to the inner pipe.

In the system, the terminal end of the radially innermost semiconductive or conductive layer can be between a low resistance centralizer and where the mid line assembly connects to the inner pipe.

In the system, the electrical insulation can be sufficiently thick to prevent electrical discharges in voids or delaminations in the electrical insulation.

The system can further include: a semiconductive tape that covers the terminal end of the radially innermost semiconductive or conductive layer, wherein one part of the semiconductive tape is attached to the radially innermost semiconductive or conductive layer and another part of the semiconductive tape is attached to the electrical insulation.

The system can further include: a compressive tape disposed on the semiconductive tape; and a mastic material disposed within a region defined by the electrical insulation, the semiconductive tape, and the terminal end of the semiconductive or conductive layer.

The system can further include: a field joint, wherein the radially innermost semiconductive or conductive layer is electrically continuous across the field joint.

The system can further include a shear stop element disposed in the annulus region. The shear stop element can be arranged such that it does not penetrate the electrical insulation layer.

In the system, the shear stop element can alternatively be arranged such that it does penetrate portions of the electrical insulation layer but does not penetrate the entire thickness of the electrical insulation layer or completely sever the semiconductive or conductive layer so as to make the semiconductive or conductive layer electrically discontinuous.

The system can further include: a water seal disposed against the shear stop element, wherein the water seal is a mastic material or a lip seal and configured to keep water from entering the annulus region.

In the system, the low resistance centralizer can be semiconductive.

The system can further include a plurality of low resistance centralizers, wherein the radially outermost conductive or semiconductive layer (second layer) disposed on the inner surface of the outer pipe makes electrical contact with at least some part of the plurality of low resistance centralizers.

In the system, where shear stop elements are used, openings (or holes) can penetrate the radially innermost semiconductive or conductive layer and partially penetrate into the electrical insulation layer to provide an anchor pattern for the shear stop element without penetrating the entire thickness of the electrical insulation layer or completely severing the semiconductive layer.

In the system, the annulus region further comprises thermal insulation disposed on the radially innermost semiconductive or conductive layer disposed on the electrical insulation layer which is disposed on the inner pipe.

A pipe-in-pipe system, including: an outer pipe; an inner pipe disposed within the outer pipe; a mid line assembly configured to connect the outer pipe and the inner pipe to a current source; and an annulus region between an outer surface of the inner pipe and an inner surface of the outer pipe, wherein the annulus region includes a conductive or semiconductive electrical path configured to carry current between the inner pipe and the outer pipe.

In the system, the conductive or semiconductive electrical path can include: electrical insulation disposed on the outer surface of the inner pipe, a semiconductive or conductive layer disposed circumferentially around the electrical insulation on the inner pipe, a conductive or semiconductive layer disposed circumferentially on the inner surface of the outer pipe, and a low resistance centralizer that electrically connects the conductive or semiconductive layer disposed on the inner surface of the outer pipe across an air gap to the semiconductive or conductive layer on the electrical insulation disposed on the outer surface of the inner pipe. Such a conductive or semiconductive electrical path may be desired to maintain a low voltage across the annulus air gap.

A pipe-in-pipe system including: an outer pipe; an inner pipe disposed within the outer pipe; a current source configured to apply voltage to the inner pipe and the outer pipe; and an annulus region between an outer surface of the inner pipe and an inner surface of the outer pipe, wherein the annulus region includes electrical insulation disposed on the outer surface of the inner pipe and an air gap, wherein the current source applies a system voltage of at most 3000 volts.

In this system, a centralizer can be located within the annulus region between the inner pipe and the outer pipe. The centralizer can be a low resistance, conductive or semiconductive centralizer or an electrically non-conductive centralizer.

In this system, the electrical insulation can have a lesser thickness in the range of from 2 mm to 6 mm.

In this system, the current source can apply a system voltage of at most 2000 volts.

In this system, a mid line assembly can be used to connect the inner pipe and the outer pipe to the current source.

A method for transporting produced fluids in a subsea pipeline including: introducing produced fluids from a well into the subsea pipeline; and heating at least a portion of the subsea pipeline using a pipe-in-pipe system as described herein.

### BRIEF DESCRIPTION OF THE DRAWINGS

While the present disclosure is susceptible to various modifications and alternative forms, specific example embodiments thereof have been shown in the drawings and are herein described in detail. It should be understood, however, that the description herein of specific example embodiments is not intended to limit the disclosure to the particular forms disclosed herein, but on the contrary, this disclosure is to cover all modifications and equivalents as defined by the appended claims. It should also be understood that the drawings are not necessarily to scale, emphasis instead being placed upon clearly illustrating principles of exemplary embodiments of the present invention. Moreover, certain dimensions may be exaggerated to help visually convey such principles.

FIG. 1 illustrates an overview of the PIP DEH configuration.

FIG. 2 illustrates current density in the pipe walls.

FIG. 3A illustrates an exemplary PIP DEH configuration.

FIG. 3B illustrates a bulk head in the PIP DEH configuration of FIG. 3A.

FIG. 4 illustrates an exemplary Mid Line Assembly (MLA) configuration.

FIGS. 5A, 5B, 5C, and 5D illustrate exemplary annulus electrical failure modes.

FIG. 6 illustrates an exemplary cross section at a thermal insulation

FIG. 7 is an exemplary cross section of the inner pipe electrical insulation.

FIG. 8 is an exemplary annulus cross section at a centralizer.

FIG. 9 is an exemplary annulus cross section at a shear stop element.

FIGS. 10A and 10B illustrate an exemplary semiconductive annulus concept for reducing annulus gap voltage.

FIG. 11 is an exemplary electrical insulation configuration at the field joint before layers are applied.

FIG. 12 is an exemplary electrical insulation configuration at the field joint after layers are applied.

FIG. 13A illustrates exemplary semiconductive annulus voltages and currents between centralizers for 3 m spacing between centralizers.

FIG. 13B illustrates exemplary semiconductive annulus voltages and currents for 3 m centralizer spacing from shear stop elements.

FIG. 14 illustrates an exemplary shear stop element/water stop element triple joint configuration.

FIGS. 15A, 15B, and 15C illustrate an exemplary preparation of the inner pipe surface preparation for anchoring shear stop elements.

FIG. 16 illustrates an exemplary horizontal shear stop element fabrication configuration.

FIG. 17 illustrates an example of a termination of the semiconductive layer near the Mid Line Assembly.

FIG. 18 illustrates an example of a termination of the semiconductive layer near the Mid Line Assembly.

FIG. 19 illustrates an exemplary PIP DEH configuration.

### DETAILED DESCRIPTION

Exemplary embodiments are described herein. However, to the extent that the following description is specific to a particular embodiment, this is intended to be for exemplary purposes only and simply provides a description of the exemplary embodiments. Accordingly, the invention is not limited to the specific embodiments described below, but rather, it includes all alternatives, modifications, and equivalents falling within the true spirit and scope of the appended claims.

The exemplary embodiments describe a robust electrical insulating annulus design for the Pipe in Pipe Direct Electric Heating (PIP DEH) system.

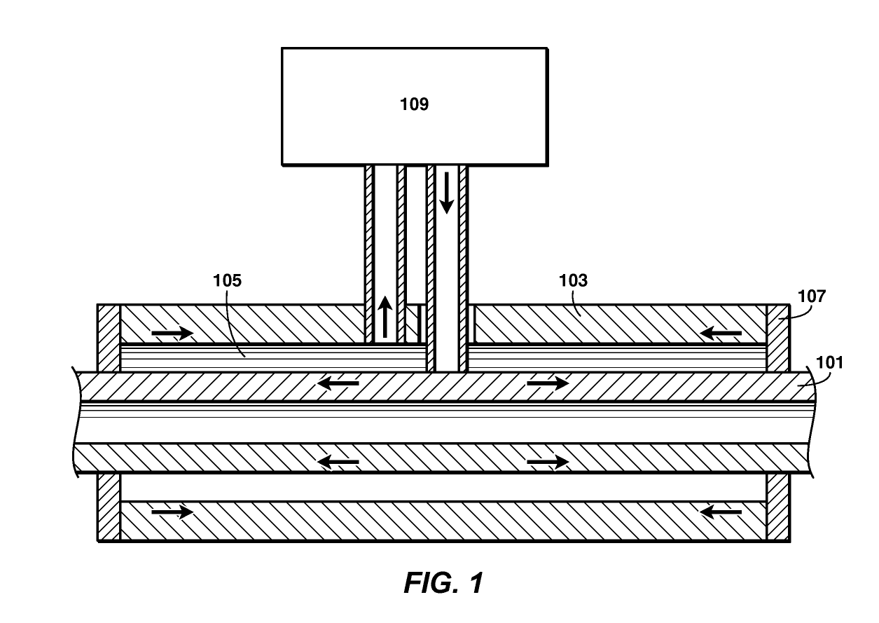

FIG. 1 illustrates an overview of how electric current is used to generate heat in a pipe-in-pipe heating configuration. The PIP DEH configuration is heated by using the inner pipe 101 and outer pipe 103 as electric heating elements, configured as a coaxial electrical circuit. The annulus 105 can be filled with material(s) that provide both thermal and electrical insulation. The details of the annulus design are discussed below in connection with other figures. The inner pipe 101 and outer pipe 103 can be made of carbon steel connected by carbon steel bulkheads 107 at the end of each heated segment.

AC voltage is applied across the annulus 105 at the center of the segment by a single phase AC power supply or current source 109. Heating results from current flowing in the inner pipe 101. The arrows in FIG. 1 illustrate the flow of current during one half cycle through the electrical circuit formed from the inner pipe 101 and outer pipe 103. The current flows in the opposite direction on the other half cycle. To complete the electrical circuit, the inner pipe 101 and outer pipe 103 are connected by steel “bulkheads” 107 welded to both pipes at the end of each heated segment. These bulkheads 107 are of the same design as bulkheads in conventional pipe in pipe flow lines, but may include some thermal insulation external to the outer pipe to avoiding gelling at the cold spot formed by the bulkhead.

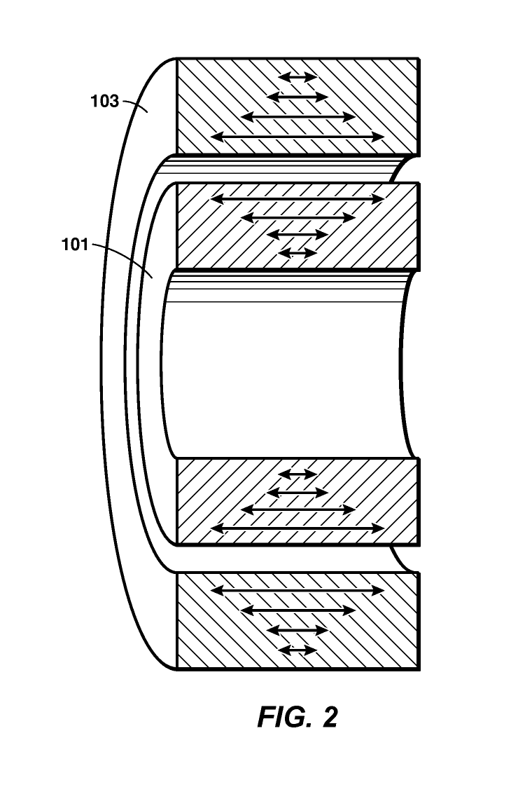

The inner pipe 101 can carry a produced fluid (i.e., hydrocarbons such as oil and/or gas produced from a well) and current flows primarily on the outer wall of inner pipe 101 (as further explained below in connection with FIG. 2 and the skin effect). The outer pipe 103 protects the material in the annulus 105 from the seawater, and current flows primarily on the inner wall of the outer pipe 103 (as further explained below in connection with FIG. 2 and the skin effect).

Alternating current flows axially along the inner and outer pipes. Due to electromagnetic effects, alternating current flows primarily near the outside surface of the inner pipe and the inside surface of the outer pipe. As shown in FIG. 2, the axial current density falls off approximately exponentially into the pipe wall as indicated by the changing size of the double-headed arrows in inner pipe 101 and outer pipe 103. The exponential depth parameter is called the skin depth and is estimated from some measurements to be 1-3 mm in carbon steel pipe walls. The skin effect is well known in electromagnetic theory and practice and a description can be found in any basic electromagnetics textbook, for example, Ramo, Whinnery, Van Duzer (1994). Fields and Waves in Communications Electronics. John Wiley and Sons. The skin effect largely isolates the current from the seawater and produced fluid flowing in inner pipe 101.

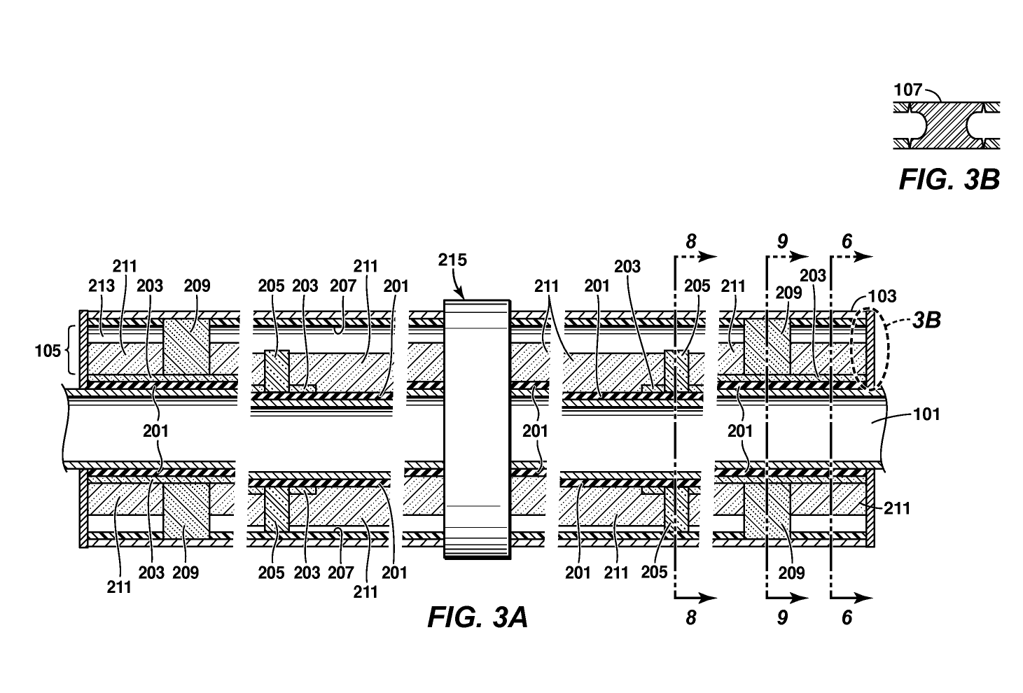

FIG. 3A illustrates an exemplary PIP DEH configuration. With respect to the Figures, similar features utilize similar reference numerals. Despite how it may appear, inner pipe 101 is continuous (possibly through welded joints), and FIG. 3A is drawn to indicate, in an exaggerated manner, how inner pipe 101 may bend, flex, or be contorted while disposed within outer pipe 103. FIG. 3A, like all the figures, is not drawn to scale. Particularly, FIG. 3A shows that different sections of the pipeline have different centering orientations. Each piece is like a slice out of a section of the pipeline. Every element of the pipeline, including the layers, is actually continuous across the gaps, which are not really physical gaps but just a way to show the centering in different sections of the pipeline.

FIG. 3A provides additional details regarding the annulus 105. The annulus 105 can have a semiconductive electrical design that prevents electrical discharges in the annulus gap regardless of contamination. The annulus 105 can include electrical insulation 201 circumferentially disposed on the inner pipe 101, a semiconductive layer (e.g., coating) (first layer) 203 concentrically disposed on the electrical insulation 201, dry thermal insulation 211 concentrically disposed on the semiconductive layer 203, an air gap 213, and a conductive layer (second layer) 207 concentrically disposed on the inside of the outer pipe 103. As used herein, “on” means directly or indirectly being in physical contact. It is understood that semiconductive layer 203 may alternatively be a conductive layer and conductive layer 207 may alternatively be a semiconductive layer. While FIG. 3 depicts the dry thermal insulation 211 on the semiconductive layer 203, the dry insulation could also be disposed on the conductive layer 207.

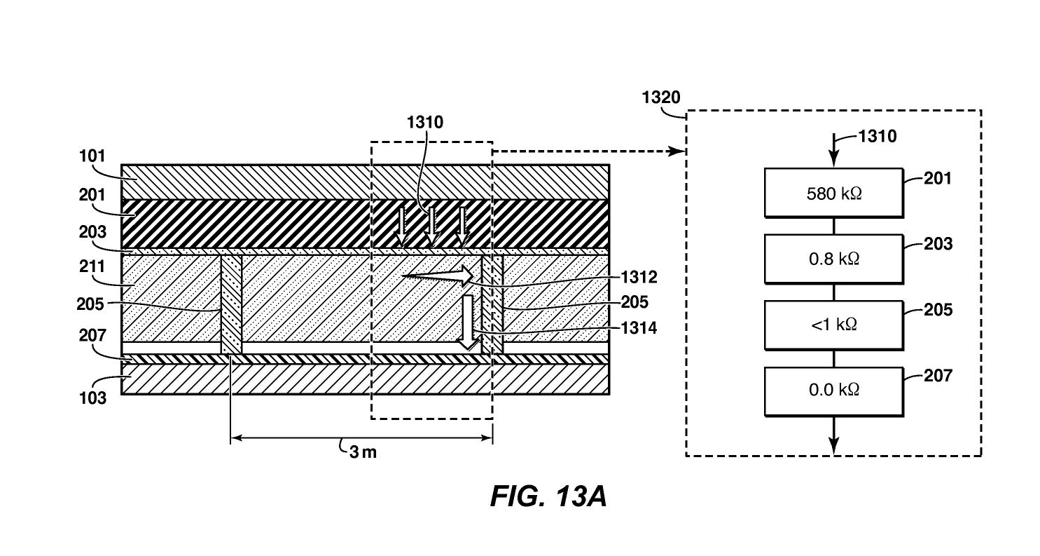

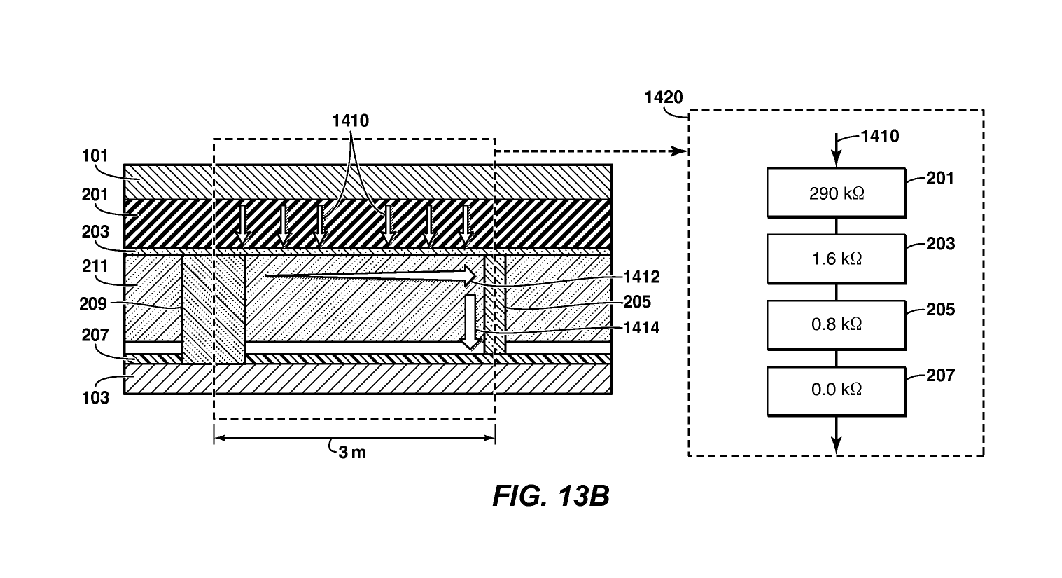

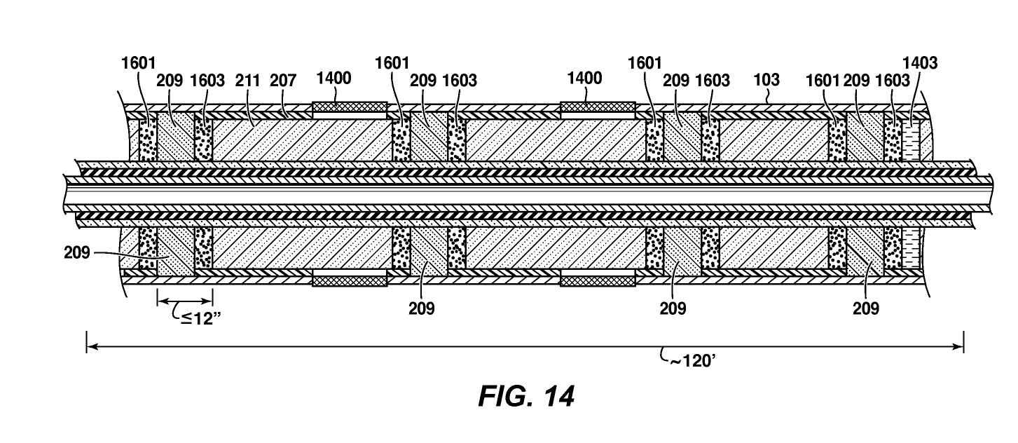

Electrical insulation 201 surrounds the outside of the inner pipe 101. The electrical insulation 201 can prevent electrical faulting from annulus contamination. The electrical insulation should be sufficiently thick to prevent internal electrical discharges that could cause eventual failure of the electrical insulation. Also, the electrical insulation should be sufficiently thick to limit current losses from capacitive leakage currents (see FIGS. 13 and 14) to acceptable levels. For example, electrical insulation 201 may have a thickness of at least 8 mm, such as approximately 12 mm.

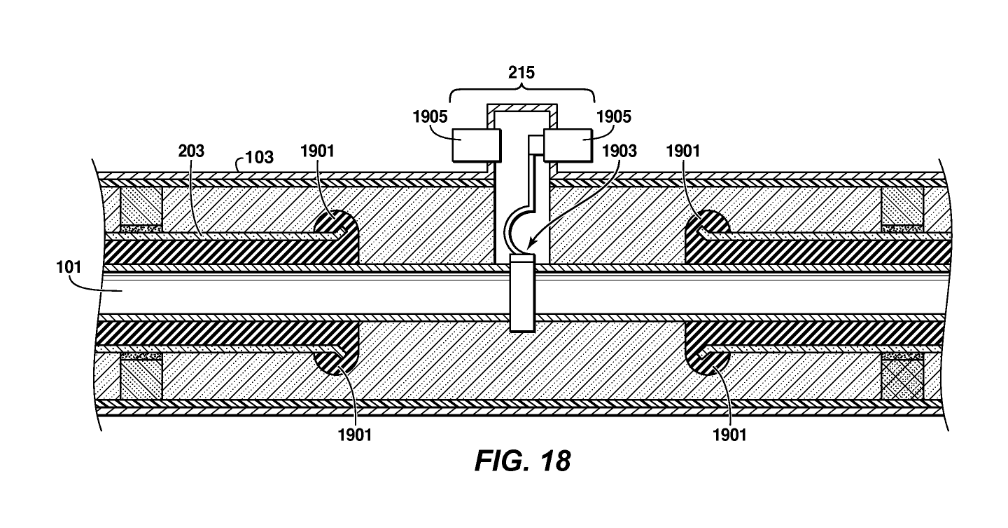

A semiconductive layer 203 is disposed on the electrical insulation 201. Layer 203 could also be conductive. The semiconductive layer 203 terminates before reaching the mid line assembly 215. Details of how semiconductive layer 203 terminates are omitted from FIG. 3 for clarity, and are discussed relative to FIG. 17 and FIG. 18. In FIG. 3A, an end of the semiconductive layer 203 terminates between the mid line assembly 215 and a centralizer 205. However, the end of semiconductive layer 203 could terminate under centralizer 205. Centralizers 205 can be conductive or semiconductive and disposed every 3 m, for example. However, the centralizers 205 do not necessarily have to be made of a semiconductive material. For example, the centralizers may be made from any material(s) that has a low resistance; for example zinc coated plastic.

A semiconductive material is defined as a material with a bulk electrical resistivity in the range of 0.1 ohm meters to 100 ohm meters. For example, a semiconductive layer resistance between centralizers of about 2000 ohms or less is acceptable. This would result from a bulk resistivity of about 3 ohm meters or less. Commercial semiconductive materials used in electric power cable applications typically come in a range of resistivity of 0.1 to 10 ohm meters. An exemplary material used for the semiconductive layer 203 has a room temperature resistivity of about 0.25 ohm meters and a resistivity at 90° C. of about 0.5 ohms meters. The actual operating temperature and resistivity of the semiconductive layer could be somewhere in between.

For purposes of this application, a low resistance centralizer is one that has a resistance of no more than about 1000 ohms between the centralizer surface against the semiconductive layer 203 and the centralizer surface against the zinc layer 207 on the inside of the outer pipe. With a bulk resistivity in the range of 0.1 to 10 ohm meters, the centralizer resistance would be in the range of 0.005 to 0.5 ohm. The technological advancement could tolerate a much higher resistivity, as high as 20,000 ohm meters. An embodiment of the low resistance centralizer is a zinc coated centralizer, which can have a resistance significantly less than 1 ohm, and possibly as low as 0.003 ohm. The thickness of the zinc layer is a determinative factor. For the zinc coated centralizer, the concept of a bulk property such as resistivity does not apply, since it is not a homogenous material but an insulator coated with a conductor.

Within the annulus 105, there can be an air gap 213 above (radially outward of) the semiconductive layer 203, and then a conductive layer 207 on the inside of the outer pipe 103. The conductive layer 207 provides an electrical contact at some of the centralizers. Additionally, dry thermal insulation 211 can occupy at least some of the space of the air gap between the semiconductive layer 203 and conductive layer 207.

The shear stop elements 209 and water stop elements can be used in the pipe-in-pipe system to prevent flooding during installation and protect the inner piper from compressive failure. The shear stop elements/water stop elements can be spaced every 200-1000 m (for example), depending on project requirements.

The shear stop elements/water stop elements can be kept short (in the direction parallel to the central axis of the pipes) in order to prevent gelling from cooling during shutdowns.

The structure in FIG. 3A can form a semiconductive annulus circuit, which includes 3 components: (1) a semiconductive layer outside of and on the electrical insulation (for example, 2 mm thick polyethylene mixed with carbon black, and have a resistivity of no more than about 1 ohm meters); (2) low resistance centralizers (for example, the centralizer can be made of Nylon ® mixed with carbon black, and have a resistivity of no more than 100 ohm meters); and (3) a thin conductive layer on the inside of the outer pipe (for example, Sherwin Williams Zinc Clad® IV organic zinc-rich epoxy primer with a thickness of 0.1 mm) Spacing of the centralizers can be about 3 meters, but will be determined so as to prevent outer pipe buckling and maintain an acceptable annulus gap voltage.

FIG. 3B shows an exemplary cross-section of bulkhead 107.

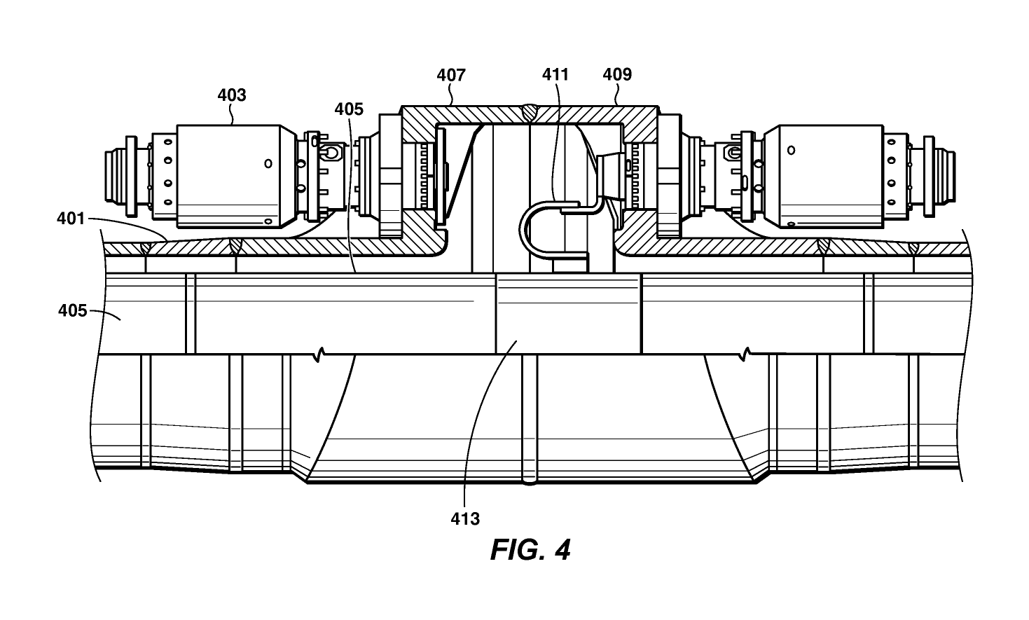

Mid line assembly 215 can deliver electric current to the pipeline, as discussed relative to FIG. 1. An example of the mid line assembly is shown in FIG. 4. The mid line assembly can include split sleeve 401, wet mate connector 403, inner housing 405 (or inner pipe 101), low voltage forging 407, high voltage forging 409, copper braid 411, and thermal sprayed copper 413. For clarity, FIG. 4 does not show the thermal insulation, centralizers, and shear stop elements in the annular space.

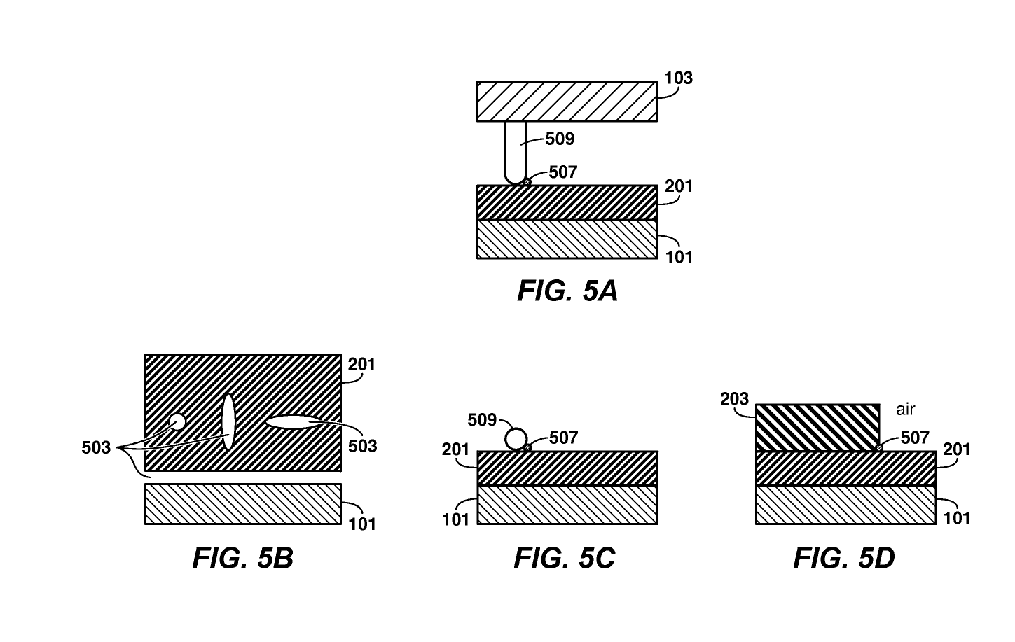

FIGS. 5A, 5B, 5C, and 5D illustrate exemplary annulus electrical failure modes. These failure modes can be prevented by a pipe-in-pipe system using the present technological advancement. The failure modes addressable by the present technological advancement include, but are not necessarily limited thereto, faulting from contamination bridging the entire annulus between the inner pipe 101 and outer pipe 103 in FIG. 5A, long term degradation of electrical insulation from partial discharge, due to contaminants 509 bridging the annulus gap (water, oils, scale, char, weld bead, etc.), voids and delamination in the electrical insulation (as shown in FIG. 5B), other triple junctions as depicted in FIGS. 5C and 5D, and partial discharge at the termination near the mid line assembly of the semiconductive layer 203 (without a terminal end as discussed below). Electrical discharge may occur at the locations marked with dots 507. Triple junctions are points of convergence for (i) a gas and two different insulators (dielectrics), or (ii) a gas, insulator, and metal.

The possibility of partial discharges in the annulus resulting from the presence of contamination 509 can be addressed by using semiconductive layer 203 and conductive or semiconductive centralizers 205 to maintain an electric field in the annulus gap below the level that could produce partial discharges. The possibility of partial discharges due to voids or delamination 503 can be addressed by using the electrical insulation 201 with a sufficient thickness, which will maintain electric fields below levels that would produce partial electric discharges in the voids or delamination in the electrical insulation 201. The possibility of partial discharges in the annulus resulting from the terminal end of the semiconductive layer 203 are addressed by configuring the terminal end of the semiconductive layer 203 with a geometry discussed below.

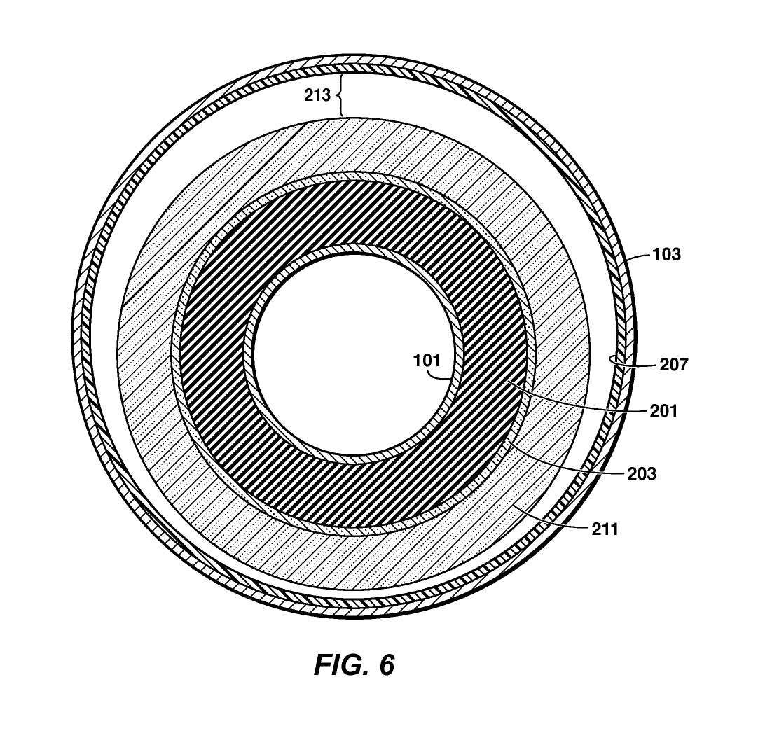

FIGS. 6 through 9 illustrate exemplary cross sections of the pipe-in-pipe arrangement of FIG. 3. FIGS. 6 through 9 are based on a design example with an inner pipe 101 that has an inner diameter (i.d.) of about 20 inches.

FIG. 6 illustrates an exemplary cross section of the pipe-in-pipe arrangement of FIG. 3, taken at 6-6 across the thermal insulation. Table 1, below, provides exemplary dimensions of the inner pipe 101, electrical insulation 201, semiconductive layer 203, thermal insulation 211, air gap 213, conductive layer 207, total annulus, and outer pipe 103.

TABLE 1

| | | outside diam- | inside diam- | thick- |
|---|---|---|---|---|
| | | eter mm | eter mm | ness mm |
| inner pipe | | 558.8 | 495.3 | 31.75 |
| | electrical insulation | 585.2 | 558.8 | 12.6 |
| | semiconductive coating | 588.2 | | 2 |
| | thermal insulation | 636.55 | | 21.275 |
| | gap | 666.55 | | 18 |
| | conductive coating | 666.75 | | 0.1 |

| | | | |
|---|---|---|---|
| total annulus | | 666.75 | 53.975 |
| outer pipe | 736.6 | 666.75 | |

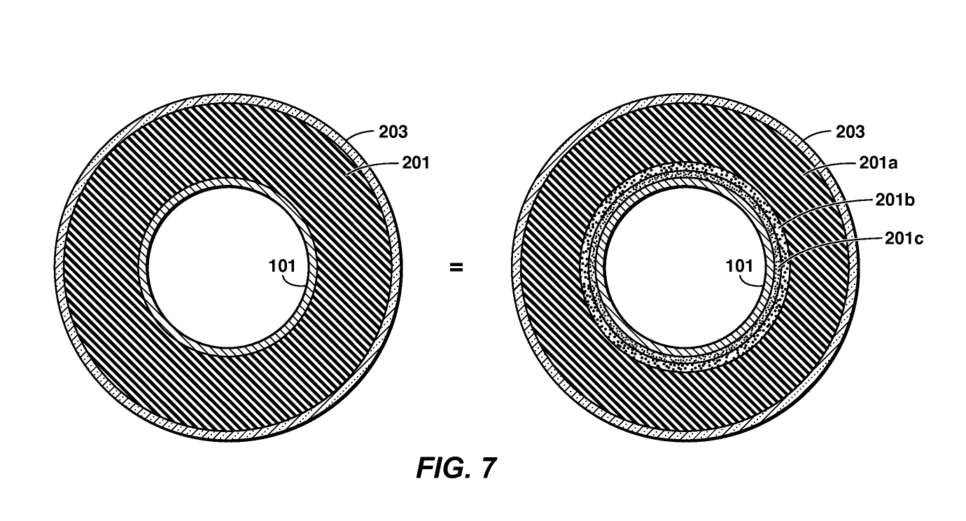

FIG. 7 illustrates another exemplary cross section of the pipe-in-pipe arrangement of FIG. 3, taken at 6-6, wherein the thermal insulation is omitted in order to provide additional detail regarding the electrical insulation. Table 2, below, provides exemplary dimensions of the multiple sub-layers that can constitute electrical insulation 201. The electrical insulation 201 can include fusion bond epoxy primer (FBE) 201c on the inner pipe 101, adhesive 201b on the FBE 201c, and modified polypropylene (PP) or polyethylene (PE) polymer 201a on the adhesive 201b. An example of the modified polypropylene polymer 201a is Borealis Borcoat™ EA 165E. An example of adhesive 201b is Borealis Borcoat™ BB 127E. An example of FBE 201c is Jotun Corro-coat EPF 1003. An example of the semiconductive layer 203 is a rubberized polyethylene layer filled with conducting pigment to about 1 ohm meters resistivity, or Borealis LE0563. An example of the conductive layer on the outer pipe is a zinc layer such as Sherwin Williams Zinc Clad® IV organic zinc-rich epoxy primer.

TABLE 2

| | | outside diam- | inside diam- | thick- |
|---|---|---|---|---|
| | | eter mm | eter mm | ness mm |
| inner pipe | | 558.8 | 495.3 | 31.75 |
| | FBE | 622.3 | 558.8 | 0.25 |
| | adhesive | 622.8 | 622.3 | 0.15 |
| | modified PP | 623.1 | 622.8 | 12.2 |

| | | | |
|---|---|---|---|
| total electrical insulation | 623.1 | 558.8 | 12.6 |

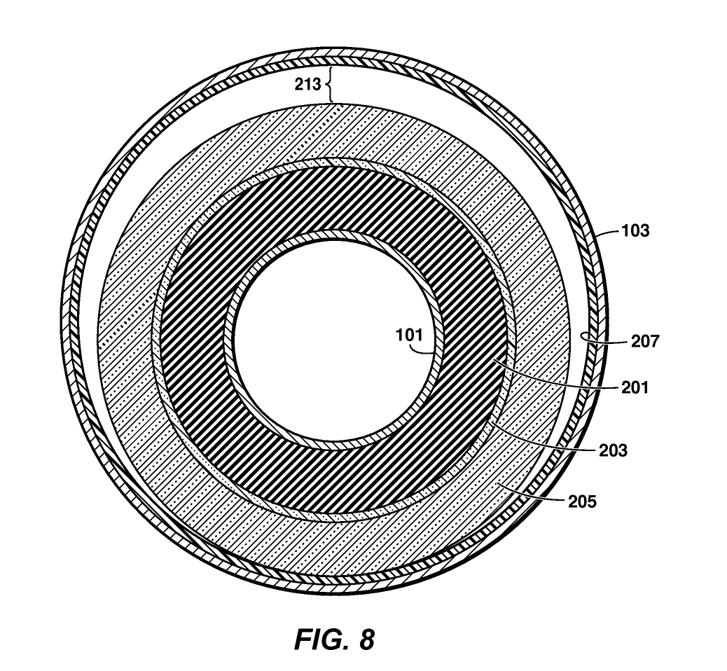

FIG. 8 illustrates an exemplary cross section of the pipe-in-pipe arrangement of FIG. 3, taken at 8-8 across a centralizer 205. Table 3, below, provides exemplary dimensions of the inner pipe 101, electrical insulation 201, semiconductive layer 203, centralizer 205, air gap 213, conductive layer 207, total annulus, and outer pipe 103.

| | | outside diam- | inside diam- | thick- |
|---|---|---|---|---|
| | | eter mm | eter mm | ness mm |
| inner pipe | | 558.8 | 495.3 | 31.75 |
| | electrical insulation | 585.2 | 558.8 | 12.6 |
| | semiconductive coating | 588.2 | | 2 |
| | centralizer | 650.75 | | 31.275 |
| | gap | 666.55 | | 8 |
| | conductive coating | 666.75 | | 0.1 |

| | | | |
|---|---|---|---|
| total annulus | | 666.75 | 53.975 |
| outer pipe | 736.6 | 666.75 | |

An example of the centralizer material is an electrically non-conducting material, for example Nylacast CF 110, coated with zinc (and optionally covered with a thin steel “shoe” on the outside surface for abrasion resistance).

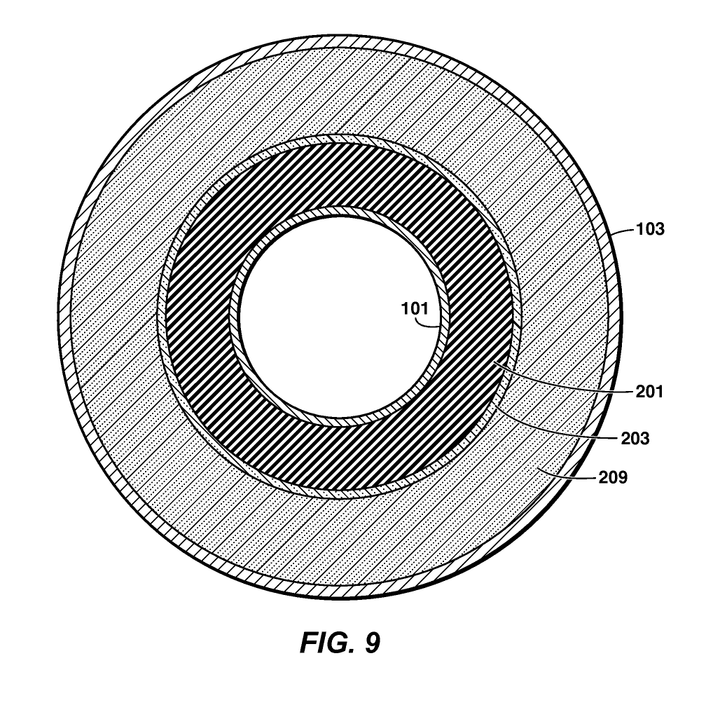

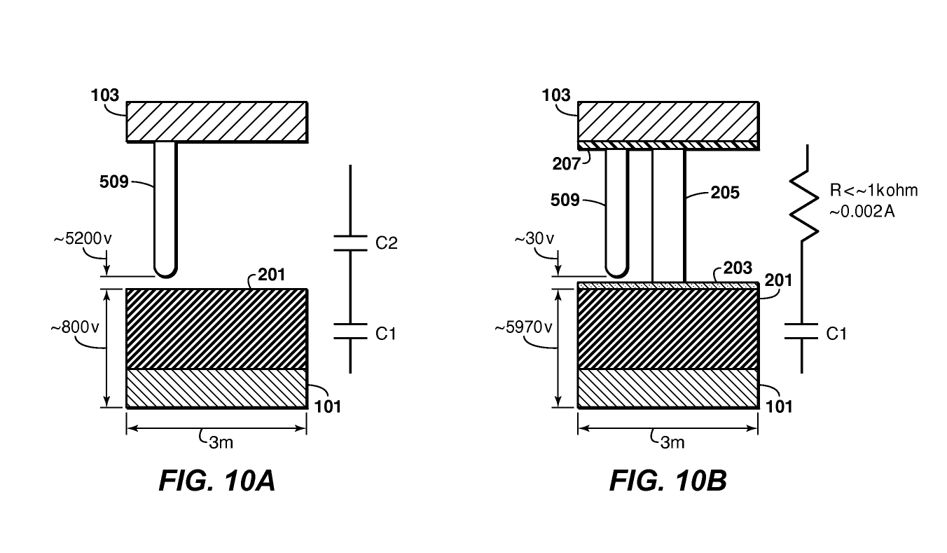

FIG. 9 illustrates an exemplary cross section of the pipe-in-pipe arrangement of FIG. 3, taken at 9-9 across a shear stop element 209. Table 3, below, provides exemplary dimensions of the inner pipe 101, electrical insulation 201, semiconductive layer 203, shear stop element 209, total annulus, and outer pipe 103.

TABLE 4

| | | outside diam- | inside diam- | thick- |
|---|---|---|---|---|
| | | eter mm | eter mm | ness mm |
| inner pipe | | 558.8 | 495.3 | 31.75 |
| | electrical insulation | 585.2 | 558.8 | 12.6 |
| | semiconductive coating | 588.2 | | 2 |
| | epoxy primer | 636.55 | | 0.4 |
| | shear stop | 666.55 | | 38.875 |
| | conductive coating | 666.75 | | 0.1 |

| | | | |
|---|---|---|---|
| total annulus | | 666.75 | 53.975 |
| outer pipe | 736.6 | 666.75 | |

In the examples of FIGS. 3 and 6-9, the annulus gap voltage should be less than about 3000 volts in order to prevent partial discharge in the annulus gap for worst-case contamination material and geometry. FIGS. 10A and 10B illustrates the annulus concept of the present technological advancement for reducing annulus gap voltage. As shown in FIGS. 10A and 10B, an exemplary benefit of the annulus of the present technological advancement is to provide a relatively low resistance path from the outside of the electrical insulation to the outer pipe. Without the annulus of the present technological advancement (FIG. 10A), the annulus gap voltage is close to the applied alternating current root mean square voltage (V AC RMS) of 6000 V AC RMS. The annulus gap voltage is approximately a result of a division of the applied voltage between the electrical insulation capacitance and the annulus gap capacitance. The division of voltage in FIG. 10A would be acceptable if no contamination is present. However, a good design should plan for and address a worst-case contamination scenario. In a worst-case contamination scenario, the maximum electric field strength in the annulus gap could be no more than one half the field strength required for electrical discharge to occur. Discharges associated with this size electric field could damage or destroy the electrical insulation over time.

With an annulus embodying the present technological advancement (FIG. 10B), the annulus gap voltage is much smaller; about 30 volts in this example. The annulus gap voltage is approximately a result of division of the applied voltage between the electrical insulation capacitance and the circuit resistance (formed by the low resistance centralizer 205 and the semiconductive layer 203). In FIGS. 10A and 10B, capacitance gaps are depicted as C1 or C2 and resistance by R. For electrical purposes, the path created by centralizer 205, the layer 203, and the zinc layer 207 could be made from either conductive materials, semiconductive materials, or a combination of conductive or semiconductive materials. However, for the layer over the electrical insulation, semiconductive layer materials are more consistent with current pipeline fabrication practices.

Best results for managing the voltage across the annulus gap may be achieved where the entire surface of the electrical insulation 201 is covered with semiconductive layer 203, except at and near the Mid Line Assembly so that a power supply can be connected to the inner pipe. A discontinuity in the semiconductive layer 203 could create a high electric field at an edge of the discontinuity and produce a partial discharge at that location. A termination geometry for the semiconductive layer 203 is described below relative to FIG. 17 and FIG. 18.

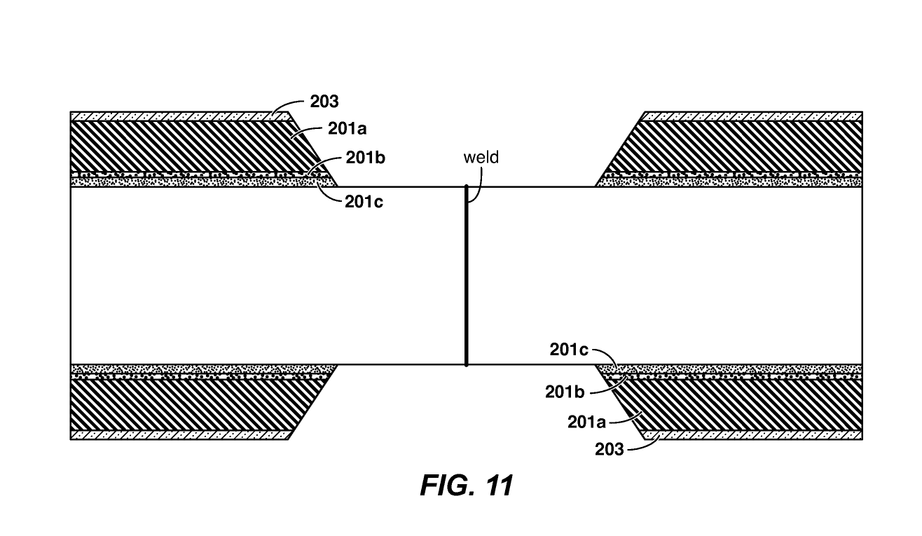

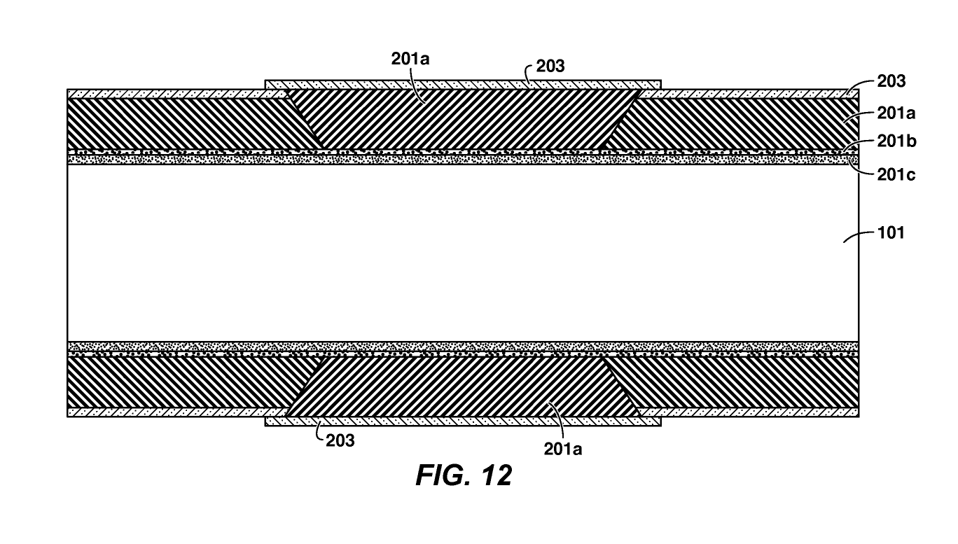

FIG. 11 illustrates an example of a field joint before application of field joint layers. FIG. 12 illustrates the application of the semiconductive layer 203 applied at the field joint, along with the electrical insulation. The electrical insulation can be a modified polypropylene (rubberized polypropylene or Borealis Borcoat™ EA 165E), and applied to the field joint via injection molding or a rotating head extruder. Both the electrical insulation layer and the semiconductive layer can be applied with a rotating head extruder, for example in sequential operations at successive work stations, such as Wehocoat-Borcoat™ FJ coating system developed by KWH LTD Finland and Borealis, WO 2008/132279 A1, but other methods of applying semiconductive, conductive or electrically insulating layers can also be used. An example of an extruded semiconductive layer is a rubberized polyethylene layer filled with conducting pigment to about 1 ohm meters resistivity or Borealis LE0563.

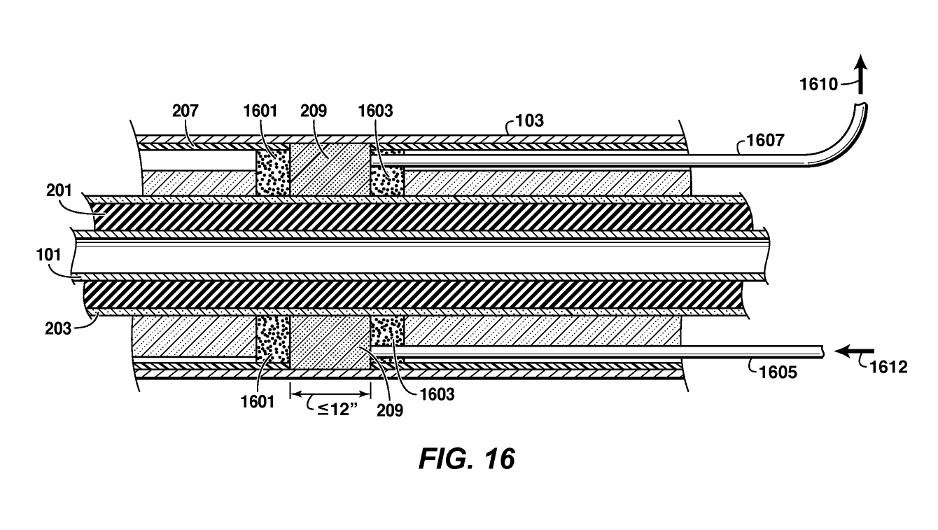

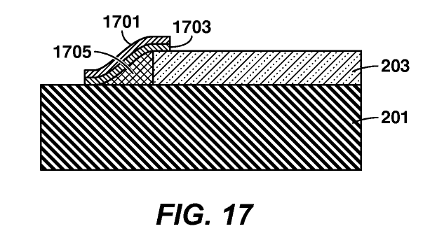

Also, the semiconductive layer 203 extends across shear stop elements as shown in FIGS. 3 and 16. The semiconductive layer 203 would also extend across any water stop elements that may be present.

FIGS. 13A and 13B illustrate circuit models for an annulus that embodies the present technological advancement. FIG. 13A illustrates the annulus voltage and currents between centralizers with 3 m spacing. The arrows 1310 in FIG. 13A depicted in the electrical insulation 201 represent the charging current flow between the inner pipe 101 and a semiconductive layer 203. The arrow 1314 in FIG. 13A represents current flow through the centralizer 205. The currents reverse direction every half-cycle. The arrows 1312 and 1412 represent an axial current along the semiconductive layer 203. The magnitude of the axial current is zero halfway between the two centralizers, and increases to a maximum at the centralizers. The farther apart adjacent centralizers are disposed, the greater the maximum voltage in the annulus gap. FIG. 13B shows current distributions between a shear stop element and an adjacent centralizer, which differ in magnitude from the currents depicted in FIG. 13A. The arrows 1410 in FIG. 13B depicted in the electrical insulation 201 represent the charging current flow between the inner pipe 101 and the semiconductive layer 203. In the examples of FIGS. 13A and 13B, there is approximately 13 volts (V) max. across the air gap (this voltage should be less than 3000 V RMS to prevent discharge in this example).

The voltage between centralizers increases with the square of the distance between the centralizers. Using shear stop elements, which are electrically insulating, provides larger spacing between adjacent centralizers than elsewhere, resulting in a higher current 1414 through the centralizer 205 than current 1314 as shown in FIG. 13A. Thus, this configuration is used to calculate a worst-case air gap voltage, as shown in FIG. 13B. In FIG. 13B, the maximum annulus gap voltage in the system appears next to shear stop elements 209 that are closest to the Mid Line Assembly (not shown), where the system voltage is applied. The annulus voltage falls off roughly linearly from the applied value at the Mid Line Assembly to zero at the bulkheads at ends of the heated section. In FIG. 13B, there is a maximum of approximately 34 V across the air gap (this voltage should be less than 3000 V RMS to prevent discharge in this example).

In the circuit models 1320 of FIG. 13A, 0.01 Amps (A) at 6 kilovolts (kV) 1310 is dropped across 580 kilo ohms (kΩ) of electrical insulation 201, which is then dropped across 0.8 kΩ of the semiconductive layer 203, which is then dropped across <1 kΩ of ½ centralizer 205, which is then dropped across an approximately 0.0 ohms (Ω) conductive layer resistance 207.

In the circuit models 1420 of FIG. 13B, 0.02 A at 6 kV 1410 is dropped across 290 kΩ of electrical insulation 201, which is then dropped across 1.6 kΩ of the semiconductive layer 203, which is then dropped across 0.8 (<1) kΩ of ½ centralizer 205, which is then dropped across an approximately 0.0Ω conductive layer resistance 207.

A predominantly capacitive current flows through the inner pipe layer across the annulus through the centralizers (see FIGS. 13A and 13B). This capacitive current causes the current in the inner pipe to vary along the pipe length. The minimum inner pipe current must be high enough to achieve the desired heating where the minimum current occurs. This means that the inner pipe current will be higher than necessary in other places on the pipe, so more power will be required than the theoretical minimum. It might be expected that the pipe current would decrease away from the midline, but it actually increases due to standing wave effects, also known as the Ferranti effect. The amount of the increase is greater the smaller the thickness of the electrical insulation layer. A thicker layer reduces the difference in current from the midline to the ends of the pipe, but also removes space that could be used for thermal insulation. So there is an optimal thickness for the electrical insulation layer to minimize total power required. The outer pipe diameter can also be increased, but at increased cost. So the thickness of the electrical insulation layer also determines overall power requirement and cost. In general, reducing total power to an acceptable level will require a thicker electrical insulation than the amount required to eliminate electrical discharges in voids and delaminations. In the examples of FIGS. 13A and 13B, the thickness of the electrical insulation for the assumed system configuration and applied voltage is about 12 mm. This is more than twice the thickness required to prevent internal partial discharges in voids and delaminations in the electrical insulation, and so is a main driver in determining an optimal thickness for the electrical insulation in this design example.

With the insulation thickness used in the design basis in the present figures, the extra power required is about 10% compared to the power requirement if the standing wave effect were not present. The insulation thickness is about twice the absolute minimum required to prevent electrical discharges in voids and delaminations and appears to be a reasonable overall compromise. However, a person of ordinary skill in the art could utilize a greater or lesser thickness, depending on particular cost and design criteria.

FIGS. 14-16 describe examples of the shear stop element useable with the present technological advancement. Shear stop elements 209 should provide adequate shear strength, not compromise the integrity of the electrical insulation or compromise electrical continuity of the semiconductive layer 203 on the inner pipe, and not create excessive cooling during a shutdown that could lead to gelling of the produced fluid at the shear stop elements, which could render the pipeline unable to start up after the shutdown. An example of the shear stop material is pumpable 1:1 epoxy or Fox Industries FX-70-6. The epoxy material may also include a silica filler or hollow glass or ceramic beads. For the system in the example of FIG. 14, shear stop element triple joints or water stop element triple joints are used every 200-1000 m. The shear stop element triple joints or water stop element triple joints prevents annulus flooding if the pipe is dropped during installation. For deeper pipelines, the shear stop element/water stop element triple joints can prevent compressive failure of the inner pipe joint.

Pipe joints installed offshore are commonly made up from three 40′ pipe sections welded together onshore. The offshore pipe joints are called triple joints. The concept for a shear stop element triple joint is shown in FIG. 14. Multiple short shear stop elements 209 are incorporated in the shear stop element triple joint to achieve the total required shear strength, while avoiding cold spots. The individual shear stop elements 209 are installed in the individual 40′ pipe sections, and the 40′ pipe sections are then welded together using conventional split sleeves (with butt welds and axial welds) 1400.

As needed, a water seal 1403 may be applied against one of the shear stop elements 209 to function as a water stop element. The water seal 1403 may include the shear stop element itself, a conventional lip seal made as short as possible to minimize heat loss, or a mastic material installed next to the shear stop element. Mastic material has not been previously used for this purpose in pipeline applications. Rubber seal 1601 is positioned along one side of the shear stop elements 209. The individual shear stop elements 209 can be kept short, in this example less than or equal to 12 inches (30.5 centimeters (cm)) in a direction approximately parallel to a central axis of the inner pipe, in order to avoid plugging caused by gels cooling at the shear stop element. Multiple short shear stop elements 209 are distributed across a triple joint to achieve total required shear strength. For a 20 inch (51 cm) inner diameter inner pipe, a maximum shear stop element length of 12 inches (30.5 cm) will prevent gelling during shut-in for a 50° C. gel temperature. Longer shear stop elements can be used for fluids with lower gel temperatures. For a given temperature target and heating current, shear stop element lengths can also be increased by reducing heat losses. Heat losses can be reduced by adding thermal insulation to the exterior of the shear stop triple joint, or by using a filler material in the epoxy with a low thermal conductivity, such as commercially available glass or ceramic microspheres. Depending on the fluid temperature required and the epoxy filler material used, external thermal insulation may be added to the shear stop element triple joint to achieve temperature targets.

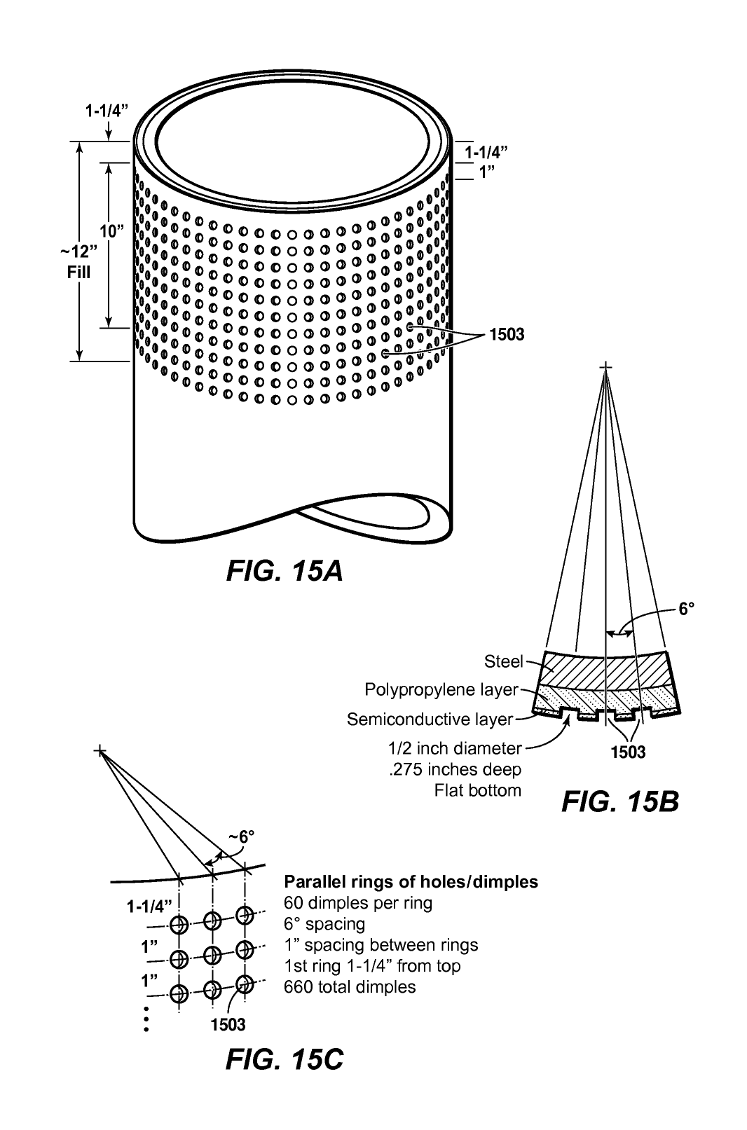

In conjunction with the present technological advancement, openings (holes) having a diameter in the range of from 0.33 inch to 1 inch (8 mm to 25 mm), for example approximately 0.5 inch (13 millimeters (mm)) in diameter, may be drilled through the semiconductive layer 203 and into the electrical insulation layer 201 to a maximum depth such that a minimum thickness of the electrical insulation layer is maintained to prevent electrical breakdown in any delaminations or voids that may be present, for example approximately 0.275 inches (7 mm) from the outside of the semiconductive layer 203 and penetrating into the electrical insulation layer 201. The openings provide an anchor pattern for the shear stop element 209 while maintaining electrical continuity of the semiconductive layer 203. Any number of openings may be used and the openings may be spaced at least two opening diameters apart measured center to center of the openings. The shear stop elements 209 penetrate but do not sever the semiconductive layer 203 so as to make the semiconductive layer 203 electrically discontinuous. As shown in FIGS. 15A-15C, the opening (hole) pattern, including a plurality of openings, in the semiconductive layer is not a penetration that makes the semiconductive layer electrically discontinuous. It is not preferred to cut the electrical insulation away and install the shear stop element between the inner and outer pipe, because a discontinuity would be introduced into the semiconductive layer 203, and a risk is introduced that a contamination path could exist if the shear stop element 209 is not effectively sealed to the electrical insulation 201 at the edges of the cut.

The inside surface of the outer pipe is coated with conductive material 207, which is selected to provide good electrical contact with the centralizer 205. For simplicity of fabrication, preferably the entire inner surface of the outer pipe 103 is coated with this same conductive material 207 in order to provide electrical continuity between the centralizers and the outer pipe. At the shear stop elements, the coating 207 may be removed and the surface roughened, for example by grit-blasting, to enable good bonding strength between the epoxy in the shear stop element 209 and the inside surface of the outer pipe 103.

The shear stop material can be an epoxy, and is chosen for shear strength and bonding properties. The semiconductive layer 203 may not sufficiently bond to the underlying electrical insulation layer 201 to carry the required load on the shear stop element. A pattern of openings (holes) may be created through the semiconductive layer 203 and part way, but not all the way, through the electrical insulation material 201 to provide a mechanical anchor pattern in the electrical insulation material 201 for the shear stop element, without compromising the electrical integrity of the semiconductive layer 203.

FIGS. 15A-15C illustrate an example of how the surface of the semiconductive layer and electrical insulation material can be prepared. To provide an anchor pattern for the shear stop elements, openings (holes) 1503 are created in a rectilinear grid pattern in the outer surface of approximately 0.5 inch (13 mm) diameter, approximately one inch (25 mm) center-to-center spacing and a depth of approximately 0.275 inch (7 mm) from the outside surface of the semiconductive layer 203. The openings 1503 provide a mechanical gripping surface (anchor pattern) that is a main source of shear strength at the interface between the shear stop element 209 and the electrical insulation layer 201. The openings 1503 only penetrate partially through the electrical insulation layer 201 to leave enough thickness of electrical insulation 201 so that discharges cannot form in voids or delaminations in the electrical insulation 201. Although layer 203 is referenced herein as a semiconductive layer, layer 203 can also be a conductive layer such as a flame sprayed metal, for example. Even though the openings penetrate the semiconductive layer 203, the spaces between the openings carry current in the semiconductive layer 203 through the shear stop element.

Alternatively, the electrical insulation layer 201 may not be penetrated by the shear stop element 209. The semiconductive layer 203 may be embossed with dimples or indentations proximate the shear shop element to provide a mechanical gripping surface. The semiconductive layer 203 may be heated to soften the layer prior to embossing and an embossing roller may be used to emboss the surface of the semiconductive layer 203. The indentations may be of any suitable shape, for example diamond shaped indentations approximately 1.5 mm in depth and approximately 2 mm in width. The dimples or indentations may be spaced at least two diameters apart measured center to center of the dimples or indentations. The embossed surface of the semiconductive layer 203 may be treated with a reducing flame to make it chemically reactive. The embossed surface of the semiconductive layer 203 may then be immediately coated with an epoxy primer. The resulting epoxy primer layer forms a chemical bond to the activated surface of the semiconductive layer 203 and to the shear stop element 209.

FIG. 16 describes a technique used to fabricate a shear stop element. The outer pipe joints used for the shear stop element triple joint are coated on their inner surface with an electrically conductive layer 207. The inner surface of the outer pipe may be grit-blasted to remove electrically conductive layer 207 and clean and roughen the inner surface of the outer pipe 103. The shear stop element is then fabricated by pouring the shear stop epoxy material into the annulus. For convenience during fabrication, the shear stop element may be poured with the pipe in a horizontal position, as shown in FIG. 16.

A first rubber seal 1601 is pushed into the annulus to the far side of the intended shear stop element 209. The seal consists of a stiff sheet of rubber with a center hole whose diameter is slightly smaller than the outside of the semiconductive layer 203, so it will seal against moderate pressure at that surface, but still be capable of being pushed into the pipe. The outer diameter is slightly larger than the inside diameter of the outer pipe inner layer 207, so it will seal against moderate pressure at that surface, but still be capable of being pushed into the pipe. A second rubber seal 1603 is pushed into the annulus to the position of the near side of the shear stop element 209. This seal is identical to the first seal, but is equipped with an injection tube 1605 at the bottom and a vent tube 1607 at the top for injection of the shear stop material. The tubes are preferably of an electrically non-conductive material such as a rubber or plastic. The shear stop material is injected into the injection tube as depicted by arrow 1612 until it is seen to be exiting the vent tube as depicted by arrow 1610. The vent tube exit is above the highest point of the shear stop element. The shear stop element is allowed to set, and then the tubes are cut off, preferably near the seal surface through which they penetrate.

Alternatively, the pipe can be upended in to a vertical position, after which a first seal 1601 is installed as before, the shear stop material is poured on top of the first seal 1601 to the desired depth and allowed to set with the pipe remaining in a vertical position.

With either fabrication method, a water stop element can be fabricated by pushing a lip seal, such as a conventional lip seal, against a shear stop element, or injecting or placing a mastic material against a shear stop element using the same or similar methods used to install the shear stop material.

FIG. 17 illustrates the geometry of an electrical termination of the semiconductive layer 203 near the Mid Line Assembly (not shown). To apply power to the system, an electrical connection must be made from the Mid Line Assembly to both the inner and outer pipes, as shown in FIGS. 1 and 4. To connect power to the inner pipe, the semiconductive layer 203 and electrical insulation 201 on the inner pipe must be removed near the point of power connection. If these materials are simply cut away near the connection, a high electric field would result at the edge of the semiconductive layer that could cause partial discharge, possibly damaging and eventually destroying the electrical insulation.

To prevent this failure mode, the geometry of the termination of the semiconductive layer near the Mid Line Assembly is modified to result in field strengths at that location that will not produce partial discharges. FIG. 17 shows an example of a feasible termination configuration, using semiconductive tape 1703, compressive tape 1701, and mastic material 1705. The semiconductive layer 203 termination is situated in a sealed environment between shear stop elements in the Mid Line Assembly and cannot be contaminated after it is fabricated. Consequently, no electrical insulation or semiconductive layer is required in this area. The Mid Line Assembly is fabricated in a contamination-free shop setting and tested for partial discharge after fabrication.

A commercially available stress grading tape, CoronaShield ® can be used for the termination configuration in FIG. 17.

FIG. 18 illustrates an alternative geometry of an electrical termination of the semiconductive layer near the Mid Line Assembly 215. FIG. 18 uses a stress cone geometry 1901, wherein the end of the semiconductive layer 203 is angled away from the central axis of the inner pipe and the electrical insulation wraps around and covers the end of the semiconductive layer 203. FIGS. 4 and 18 also illustrate that the Mid Line Assembly 215 can include an inner pipe power connection 411 in FIGS. 4 and 1903 in FIG. 18 and wet-mate connectors 1905 so that current can be supplied to the inner and outer pipes.

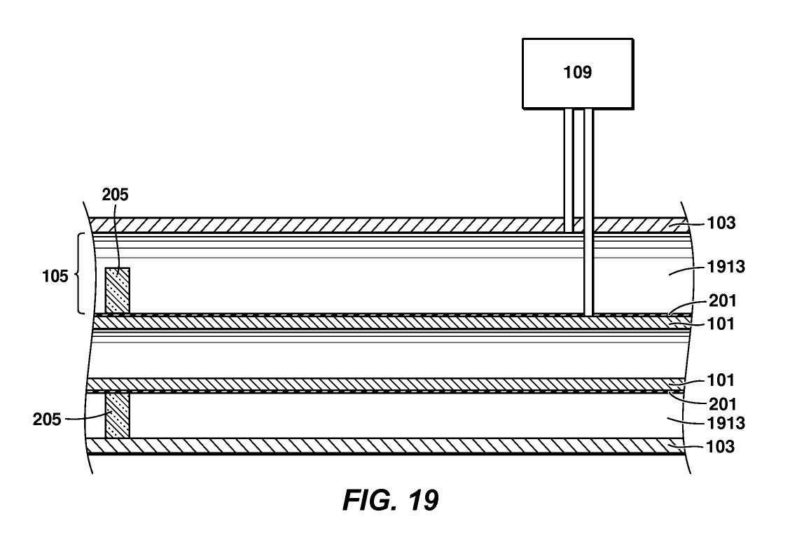

FIG. 19 illustrates an alternative PIP DEH configuration. The pipe-in-pipe system applies current to the outer pipe 103 and inner pipe 101 using current source 109. Annulus 105 includes electrical insulation 201 circumferentially disposed on the outer surface of the inner pipe 101. Annulus 105 also includes a centralizer 205 and air gap 1913. Current source 109 applies a system voltage of at most 3000 V. The current source may apply a system voltage of at most 2000 V. A mid line assembly (not shown), as described herein, may be used to connect the inner pipe and the outer pipe to the current source. The electrical insulation adjacent the outer surface of the inner pipe should be sufficiently thick to prevent electrical discharges due to contamination in the annulus and to prevent internal electrical discharges within the electrical insulation that could cause failure of the electrical insulation, for example the electrical insulation can have a thickness in the range of from 1 millimeter (mm) to 10 mm or from 2 mm to 6 mm. The centralizer 205 can be an electrically non-conductive centralizer or a low resistance, conductive or semiconductive centralizer. Although not shown in FIG. 19, the system can also include thermal insulation disposed between the electrical insulation and the inner surface of the outer pipe. The system of FIG. 19 can also include shear stop elements and water stop elements, as discussed herein.

The configuration of the pipe-in-pipe system of FIG. 19 can be used to heat shorter sections of the pipeline and still provide a design that prevents electrical discharges in the annulus regardless of contamination and prevents internal electrical discharges within the electrical insulation that could cause failure of the electrical insulation. By limiting the voltage applied to the inner pipe and outer pipe and including electrical insulation in the annulus, the design of the pipe-in-pipe system can be simplified while maintaining the ability to prevent electrical discharges.

Any of the PIP DEH systems described herein may be used to heat subsea pipelines used to transport produced fluids from a well to reduce or prevent gelling or gas hydrates, or to reduce drag from viscous fluids by maintaining them at an elevated temperature.

The present techniques may be susceptible to various modifications and alternative forms, and the examples discussed above have been shown only by way of example. However, the present techniques are not intended to be limited to the particular examples disclosed herein. Indeed, the present techniques include all alternatives, modifications, and equivalents falling within the spirit and scope of the appended claims.

What is claimed is:

1. A pipe-in-pipe system, comprising:
an outer pipe;
an inner pipe disposed within the outer pipe; and
an annulus region between an outer surface of the inner pipe and an inner surface of the outer pipe, wherein the annulus region includes
electrical insulation disposed on the outer surface of the inner pipe,
a first semiconductive or conductive layer disposed on the electrical insulation,
a second semiconductive or conductive layer disposed on the inner surface of the outer pipe, and
a low resistance centralizer that electrically connects the second semiconductive or conductive layer disposed on the inner surface of the outer pipe across an air gap to the first semiconductive or conductive layer disposed on the electrical insulation.

2. The system of claim 1, further comprising:
a mid line assembly configured to connect the outer pipe and the inner pipe to a power supply,
wherein a terminal end of the first semiconductive or conductive layer stops short of where the mid line assembly connects to the inner pipe.

3. The system of claim 2, wherein the terminal end of the first semiconductive or conductive layer is between the low resistance centralizer and where the mid line assembly connects to the inner pipe.

4. The system of claim 1, wherein the electrical insulation is sufficiently thick to prevent electrical discharges in voids or delaminations in the electrical insulation.

5. The system of claim 2, further comprising:
a semiconductive tape that covers the terminal end of the first semiconductive or conductive layer near the mid line assembly, wherein one part of the semiconductive tape is attached to the first semiconductive or conductive layer and another part of the semiconductive tape is attached to the electrical insulation.

6. The system of claim 5, further comprising:
a compressive tape disposed on the semiconductive tape; and
a mastic material disposed within a region defined by the electrical insulation, the semiconductive tape, and the terminal end of the first semiconductive or conductive layer.

7. The system of claim 1, further comprising:
a field joint, wherein the first semiconductive or conductive layer is electrically continuous across the field joint.

8. The system of claim 1, further comprising:
a field joint where the electrical insulation layer is mechanically continuous across the field joint so as to provide a barrier to contamination that is impervious to liquids or solids

9. The system of claim 1, further comprising:
a shear stop element disposed in the annulus region.

10. The system of claim 9, wherein the shear stop element does not penetrate the electrical insulation and the first semiconductive or conductive layer has an embossed surface that is bonded to the shear stop element.

11. The system of claim 9, wherein the shear stop element penetrates but does not sever the first semiconductive or conductive layer so as to make the first semiconductive or conductive layer electrically discontinuous.

12. The system of claim 9, further comprising:
a water seal disposed against the shear stop element, wherein the water seal is a mastic material and configured to keep water from entering the annulus region.

13. The system of claim 1, wherein the low resistance centralizer is semiconductive.

14. The system of claim 1, further comprising a plurality of low resistance centralizers, wherein the second semiconductive or conductive layer disposed on the inner surface of the outer pipe makes electrical contact with at least some part of the surface of the plurality of low resistance centralizers.

15. The system of claim 9, wherein the system includes a plurality of openings through the first semiconductive or conductive layer and partially through the electrical insulation layer to form a mechanical anchor pattern for the shear stop element in the electrical insulation layer.

16. The system of claim 1, wherein the annulus region further comprises thermal insulation disposed on the first semiconductive or conductive layer or the second semiconductive or conductive layer.

17. The system of claim 1, wherein the annulus region further comprises thermal insulation disposed between the first semiconductive or conductive layer and the second semiconductive or conductive layer.

18. A pipe-in-pipe system, comprising:
an outer pipe;
an inner pipe disposed within the outer pipe;
a mid line assembly configured to connect the outer pipe and the inner pipe to a current source; and
an annulus region between an outer surface of the inner pipe and an inner surface of the outer pipe, wherein the annulus region includes a conductive or semiconductive electrical path configured to carry current between the inner pipe and the outer pipe.

19. The system of claim 18, wherein the conductive or semiconductive electrical path comprises:
electrical insulation disposed on the outer surface of the inner pipe,
a first semiconductive or conductive layer disposed circumferentially around the electrical insulation on the inner pipe,
a second semiconductive or conductive layer disposed circumferentially around on the inner surface of the outer pipe, and
a low resistance centralizer that electrically connects the second semiconductive or conductive layer disposed on the inner surface of the outer pipe across an air gap to the first semiconductive or conductive layer on the electrical insulation disposed on the inner pipe.

20. A pipe-in-pipe system, comprising:
an outer pipe;
an inner pipe disposed within the outer pipe;
a current source configured to apply voltage to the inner pipe and the outer pipe; and
an annulus region between an outer surface of the inner pipe and an inner surface of the outer pipe, wherein the annulus region includes
electrical insulation disposed on the outer surface of the inner pipe, and
an air gap,
wherein the current source applies a system voltage of at most 3000 volts.

21. The system of claim 20, further comprising a non-conductive centralizer disposed within the annulus between the inner pipe and the outer pipe.

22. The system of claim 20, wherein the electrical insulation has a thickness in the range of from 2 mm to 6 mm.

23. The system of claim 20, wherein the system voltage applied to the outer pipe is at most 2000 volts.

24. A method for transporting produced fluids in a subsea pipeline comprising:
introducing produced fluids from a well into the subsea pipeline; and
heating at least a portion of the subsea pipeline using a pipe-in-pipe system comprising:
an outer pipe;
an inner pipe disposed within the outer pipe; and
an annulus region between an outer surface of the inner pipe and an inner surface of the outer pipe, wherein the annulus region includes
electrical insulation disposed on the outer surface of the inner pipe,
a first semiconductive or conductive layer disposed on the electrical insulation,
a second semiconductive or conductive layer disposed on the inner surface of the outer pipe, and
a low resistance centralizer that electrically connects the second semiconductive or conductive layer disposed on the inner surface of the outer pipe across an air gap to the first semiconductive or conductive layer disposed on the electrical insulation.
